(19) United States
(12) Patent Application Publication
(10) Pub. No.: US 2014/0200950 A1
(43) Pub. Date: Jul. 17, 2014

(54) Methods and Systems for Automatic Operation Abstraction and Custom Service Instantiation

(71) Applicant: XEROX CORPORATION, Norwalk, CT (US)

(72) Inventor: Hua Liu, Fairport, NY (US)

(73) Assignee: Xerox Corporation, Norwalk, CT (US)

(21) Appl. No.: 13/742,604

(22) Filed: Jan. 16, 2013

(51) Int. Cl. G06Q 10/06

(52) U.S. Cl. CPC G06Q 10/0633
USPC 705/7.27

(57) ABSTRACT

Methods, systems, and computer-readable media for automatically generating abstract operations and mapping inputs/outputs to efficiently automate the generation of new custom services. A computing device can identify keywords associated with one or more services and cluster the one or more services based on the keywords. Additionally, the computing device can further cluster concrete operations from the one or more services based on keywords associated with the concrete operations. Using the operation clusters, the computing device can generate abstract operations, which can be mapped to the concrete operations and between different abstract operations. Upon receipt of a request for a custom service, the computing device can select abstract operations based on an identified service cluster associated of the custom service, and can further select appropriate concrete operations based on the service cluster and/or received parameters associated with the custom service.

### TECHNICAL FIELD

The present disclosure relates generally to methods, systems, and computer-readable media for clustering software services and concrete operations to generate abstract operations for efficient instantiation of new custom services.

### BACKGROUND

Commercial and non-commercial entities may utilize custom software services for various business and non-business purposes. Abstract services can be used to reduce costs and labor in creating custom software services. An abstract service specifies the functions for a concrete service, and a concrete service s a functional custom software service. For example, an abstract banking service specifies the functions of a concrete banking service, such as creating new accounts, accepting deposits, managing employee information, etc.

Currently, abstract services must be manually defined and mapped to corresponding concrete services by programmers, and glue code must be manually developed to allow for the use of the abstract services. Such manual mapping and development is cost and labor intensive.

Accordingly, there is a need for methods and systems for automatically mapping and grouping concrete services and generating glue code to allow for efficient development a custom soft ware services.

### SUMMARY OF THE INVENTION

The present disclosure relates generally to methods, systems, and computer-readable media for automatic operation abstraction to allow for efficient custom process instantiation.

In embodiments, source code and/or specifications from existing services can be parsed to identify keywords, and the existing services can be clustered into service clusters based on the keywords. Additionally, the existing services can include various concrete operations, and the concrete operations can be clustered into operation groups based on keywords in the source code and/or specification of the operation and the service that included the operation.

Based on the operation groups, abstract operations can automatically be generated. For example, an abstract operation can be automatically generated for each operation group. Additionally, the inputs and outputs of the concrete operations in the operation group can be mapped to inputs and outputs of the abstract operation.

In further embodiments, a new custom service can be requested and parameters for the new custom service can be provided. Using the parameters, abstract operations for the new custom services can be automatically selected, and glue code can be automatically generated to map the inputs and outputs between the abstract operations. Further, using the parameters and the operation groups associated with the selected abstract operations, concrete operations can be selected and used to generate the new custom service.

### BRIEF DESCRIPTION OF THE DRAWINGS

The accompanying drawings, which are incorporated in and constitute a part of this specification, illustrate various embodiments of the present disclosure and together, with the description, serve to explain the principles of the present disclosure. In the drawings:

FIG. 1 is a diagram depicting an illustration of mappings of inputs and outputs between different abstract operations and between an abstract operation and a concrete operation associated with the abstract operation, consistent with certain disclosed embodiments;

FIG. 2 is a flow diagram illustrating an exemplary method for generating and mapping abstract operations, consistent with certain disclosed embodiments;

FIG. 3 is a flow diagram illustrating an exemplary method for instantiating a new service using abstract operations, consistent with certain disclosed embodiments;

FIG. 4 is a diagram depicting an exemplary hardware configuration for various devices that may be used to perform one or more operations of the described embodiments, consistent with certain disclosed embodiments.

### DETAILED DESCRIPTION

The following detailed description refers to the accompanying drawings. Wherever convenient, the same reference numbers are used in the drawings and the following description to refer to the same or similar parts. While several exemplary embodiments and features of the present disclosure are described herein, modifications, adaptations, and other implementations are possible, without departing from the spirit and scope of the present disclosure. Accordingly, the following detailed description does not limit the present disclosure. Instead, the proper scope of the disclosure is defined by the appended claims.

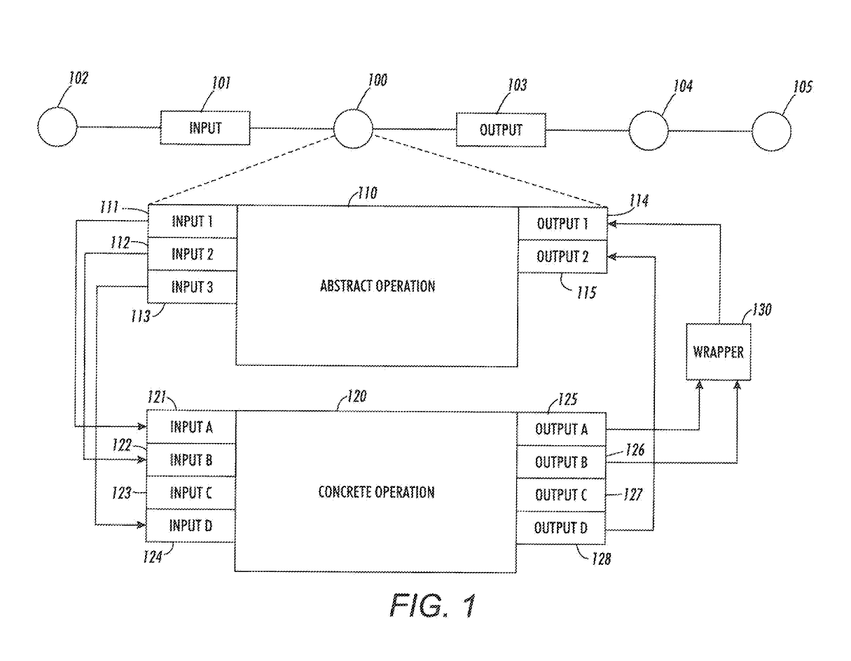

FIG. 1 is a diagram depicting an illustration of mappings of inputs and outputs between different abstract operations and between an abstract operation and a concrete operation associated with the abstract operation, consistent with certain disclosed embodiments.

As used herein, a concrete operation can be an operation within a service that performs one or more functions, such as generating output, modifying variables, throwing exceptions, etc.

Additionally, as used herein, an abstract operation can be an operation shell that is generated and/or associated with one or more concrete operations. In embodiments, an abstract operation may not individually perform any functions, such as generating outputs, modifying variables, throwing exceptions, etc. Instead, an abstract operation can define input/output types and/or names that are required to utilize concrete operations associated with the abstract operation.

As depicted in FIG. 1, an abstract operation 100 can receive an input 101 from an abstract operation 102. Input 101 can represent variable data of one or more data types, such as integers, booleans, characters, strings, floating-point numbers, arrays, objects, etc. Further, input 101 can be directly received from abstract operation 102, or input 101 can be converted from one or more results of abstract operation 102 to fit the requirements for parameters of abstract operation 100.

For example, abstract operation 102 can represent an account management operation and abstract operation 100 can represent a deposit operation for banking software. The account management operation can output an integer variable titled account_number, and the deposit operation can require an integer variable titled account_number as an input. Accordingly, input 101 can represent integer variable titled account number, which can be transferred from the account management operation to the deposit operation.

Further, abstract operation 100 can result in an output 103. Output 103 can represent variable data of one or more data types, such as integers, booleans, characters, strings, floating-point numbers, arrays, objects, etc. Further, abstract operation 100 can transfer output 103 directly to an abstract operation 104, or output 103 can be converted from one or more results of abstract operation 100 to fit requirements for parameters of abstract operation 104. Abstract operation 104 can further result in output that is received as input by an abstract operation 105, and abstract operation 105 can result in output that is used by one or more additional abstract operations.

As depicted in FIG. 1, a concrete operation 120 represents computer programming code designed to perform one or more functions. In some embodiments, concrete operation 120 can require one or more inputs, e.g. inputs A-D (121-124), to perform the one or more functions. Additionally, concrete operation 120 can result in one or more outputs, for example, outputs A-D (125-128). In alternative embodiments, concrete operation 120 may not require any inputs and/or may not result in any outputs.

As an example, concrete operation 120 can represent a deposit operation that was designed for a particular banking service. The deposit operation can require four inputs. Input A 121 can represent an integer variable titled account_number, input B 122 can represent a float variable titled deposit_amount, input C 123 can represent a boolean variable titled verified, and input D can represent an integer variable titled pin.

The deposit operation can result in four outputs. For example, output A 125 can represent an integer variable titled account_number, output B 126 can represent a float variable titled current_balance, output C 127 can represent a boo an variable titled verified, and output D 128 can represent an integer variable titled pin.

In FIG. 1, an abstract operation 110 represents an abstraction created using one or more concrete operations. In some embodiments, abstract operation 110 can be created automatically from keywords, inputs, and outputs of operations including, for example, concrete operation 120. In other embodiments, abstract operation 110 can be automatically created from keywords, inputs, and outputs of operations similar to concrete operation 120.

Abstract operation 110 represents an expanded illustration of abstract operation 100. Additionally, abstract operation 100 can he associated with inputs 1-3 (111-113) and outputs 1 and 2 (114 and 115).

In embodiments, inputs 1-3 (111-113) can represent an expanded view of input 101, received from abstract operation 102. Additionally, in further embodiments, inputs 1-3 (111-113) can represent inputs received from multiple abstract operations. Inputs 1-3 (111-113) can represent variable data of one or more data types, such as integers, booleans, characters, strings, floating-point numbers, arrays, objects, etc. Additionally, inputs 1-3 (111-113) can be converted from the results of one or more operations to data types that match the parameter requirements of abstract operation 110.

Outputs 1 and 2 (114 and 115) an represent an expanded view of output 103. Additionally, in further embodiments, outputs 1 and 2 (114 and 115) can represent outputs transferred to multiple operations. Outputs 1 and 2 (114 and 115) can represent variable data of one or more data types, such as integers, booleans, characters, strings, floating-point numbers, arrays, objects, etc. Further, outputs 1 and 2 (114 and 115) can be directly received by one or more operations, such as abstract operation 102, as parameters. Additionally, outputs 1 and 2 (114 and 115) can be converted to data types that match the parameter requirements of abstract operations that receive information from abstract operation 110.

In embodiments, the inputs of abstract operation 110 can be mapped to the inputs of concrete operation 120. For example, as depicted in FIG. 1, input 1 (111) of abstract operation 110 can be mapped to input A (121) of concrete operation 120, input 2 (112) can be mapped to input B (122), and input 3 (113) can be mapped to input D (124).

In some embodiments, not every input of abstract operation 110 may be mapped to an input of concrete operation 120, and/or not every input of concrete operation 120 may be mapped to an input of abstract operation 110. For example, as depicted in FIG. 1, input C (123) of concrete operation 120 is not mapped to an input of abstract operation 110.

In certain implementations, if an input of concrete operation 120 is not mapped to an input of abstract operation 110 (e.g. Input C 123), the missing input may be, for example, mapped to an input of a different abstract operation, or the operation can be flagged as requiring additional coding to perform the function without the required input.

Some inputs may not directly map between abstract operation 110 and concrete operation 120. IN such instances, the inputs can, for example, be converted into a format that meets the requirements of the parameters of concrete operation 120, or be wrapped into an object that meets the requirements of the parameters of concrete operation 120. if the inputs cannot be automatically converted or wrapped as described above, the operation can be flagged as requiring additional coding to allow for a proper mapping of the inputs.

In some implementations, the outputs of abstract operation 110 can be mapped to the outputs of concrete operation 120. For example, as depicted in FIG. 1, output 2 (115) of abstract operation 110 can be mapped to output D (128) of concrete operation.

In some embodiments, not every output of abstract operation 110 may be mapped to an output of concrete operation 120, and/or not every output of concrete operation 120 may be mapped to an output of abstract operation 110. For example, as depicted in FIG. 1, output C (127) of concrete operation 120 is not mapped to an output of abstract operation 110.

If an output of concrete operation 120 is not mapped to an output of abstract operation 110, the missing output may be mapped to an output for a different abstract operation, the operation may be flagged as requiring additional coding to generate the missing output, or the missing output from concrete operation 120 can be ignored, etc.

Some outputs may not directly map between abstract operation 110 and concrete operation 120. In such instances, the outputs can for example, be converted into a format that matches the expected output format of abstract operation 110, or can be wrapped into an object that matches the expected output format of abstract operation 110.

For example, as depicted in FIG. 1, outputs A and B (125 and 126) can be wrapped (e.g. using Wrapper 130) into an object containing information from both outputs. For instance, output A (125) could represent an integer titled account number and output B (126) could represent a floating variable titled account balance. Wrapper 130 could provide conversion between the integer type and the floating type.

If the outputs cannot be automatically converted as described above, in some embodiments, the operation can be tagged as requiring additional coding to allow for a proper mapping of the outputs.

Those skilled in the art will appreciate that the foregoing illustration is exemplary only, and that various different configurations of abstract operations, concrete operations, inputs, and outputs may be utilized, consistent with certain disclosed embodiments. For example, an abstract operation may be associated with and/or be generated from more than one concrete operation. Additionally, abstract operations and concrete operations may have one or more inputs and one or more outputs, or, in sonic embodiments, may have no inputs and/or outputs.

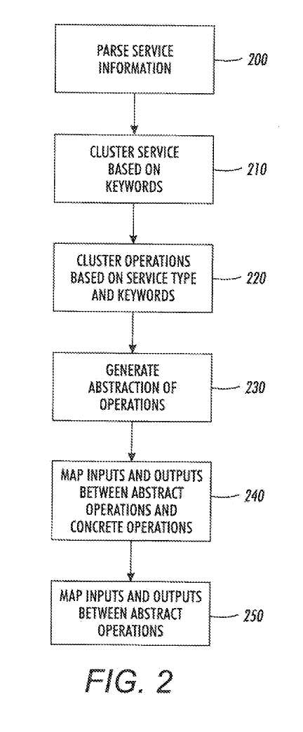

FIG. 2 is a flow diagram illustrating an exemplary method for generating and mapping abstract operations, consistent with certain disclosed embodiments.

In 200, a computing device can begin parsing service information of one or more software services. For example, the computing device can parse the source code of the service and/or specifications associated with the service. The process can begin, for example, after a request is received from a user, after source code and/or specifications of the one or more software services are received by the computing device, etc.

The computing device can parse and tokenize the text of the source code and/or specification and identify keywords to determine service names, operation names, file types and names, port types and names, input/output types and names, input/output parameter names, variable data types and names, error names, etc. For example, the computing device can identify words in CamelCase, words that utilize non-letters (e.g. an underscore), stop words, markup language tags, single letter words that are unlikely to be keywords, etc., and can tokenize keywords accordingly.

As an example, based on the tokenized keywords, the computing device can determine that a service contains operations titled deposit, withdraw, and account verification, and that the operations include inputs and outputs titled account number, account balance, and pin number.

In some embodiments, the computing device can identify keywords that match words from a specific word list or dictionary. Further, the computing devices may identify misspellings, different spellings, synonyms, etc. of known words. The specific word list or dictionary can be selected, in some instances, based on other keywords identified in the software service,

In 210, the computing device can cluster the one or more services based on the keywords recognized in 200. In some embodiments, pairs of services can be compared and a similarity distance between the two services can be calculated. For instance, a bipartite graph can be utilized where the nodes represent the keywords for a pair of services and the edges arc values representing the similarity distance between two keywords. A large distance between keywords can indicate that the keywords are likely not similar. A small distance between keywords can indicate that the keywords are likely similar. Similarity distance between the pair of services can be calculated by cumulating the distances between keywords associated with the services.

For example, the keywords recognized for a first banking service may include many keywords similar to the keywords recognized for a second banking service. Accordingly, a calculated similarity distance between the two clustered services may be relatively small. As an alternative example, the keywords recognized for the first banking service may not include many keywords similar to the keywords recognized for a customer management service. Accordingly, a calculated distance between the two clustered services may be relatively large.

The one or more software services can be clustered based on the similarity distances between pairs of services. A service cluster can represent a grouping of one or more software services. In some embodiments, a cluster cohesion can be calculated. A cluster cohesion can represent the maximum distance between any pair of services in the cluster. A cluster average distance can also be calculated, where the duster average distance can represent the average distance between pairs of services in the cluster. Service clusters can be continuously merged together until optimum balances between cluster cohesions and cluster average distances are found.

In some embodiments, the boundaries of the service clusters can be determined using a hierarchical clustering algorithm. For example, two service clusters can be merged as long as the cluster average distance is smaller than the sum of the cluster cohesion. Additionally, in some embodiments, a threshold cluster cohesion and/or cluster average distance may be used to cluster the services. Further, in certain implementations, the service clusters can be determined by merging service clusters until an overlap between service clusters would occur. Additional embodiments can allow for overlapping service clusters.

In further embodiments, an association certainty can be calculated based on the level of certainty that a given service should be associated with a service cluster. For example, if a service has a higher than average cluster average distance between one or more services in the cluster, than a low level of association certainty with the service cluster can be assigned to the service.

In 220, the computing device can cluster operations based on the keywords recognized in 200 and further based on the service clusters created in 210. In some embodiments, pairs of operations from services in the same cluster can be compared and a similarity distance between the two operations can be calculated. For instance, a bipartite graph can be utilized, where the nodes represent the keywords for a pair of operations and the edges are values representing the similarity distance between two keywords from the operations. A large distance between keywords can indicate that the keywords arc likely not similar. A small distance can indicate that the keywords are likely similar. Similarity distance between the pair of services can be calculated by cumulating the distances between keywords associated with the operations.

For example, the keywords recognized from a deposit operation for a first banking service may include many keywords similar to the keywords recognized for a deposit operation for a second banking service clustered with the first banking service. Accordingly, a calculated similarity distance between the two clustered operations may be relatively small. As an alternative example, the keywords recognized for the deposit operation for the first banking service may not include many keywords similar to the keywords recognized for a withdrawal operation for the second banking service. Accordingly, a calculated distance between the two clustered operations may be relatively large.

Although the above example illustrates a comparison between operations from two services that were clustered together in 210, in some embodiments, an operation from one service may be compared to an operation from a second service, even if the two services were not clustered in 210. In some embodiments, the similarity difference between the two services may or may not be used in calculating the similarity difference between the two operations.

The one or more operations can be clustered based on the similarity distances between pairs of operations. An operation cluster can represent a grouping of one or more operations. In some embodiments, a cluster cohesion can be calculated. A cluster cohesion can represent the maximum distance between any pair of operations in the duster. A cluster average distance can also be calculated. A cluster average distance can represent the average distance between pairs of operations in the cluster. Operation clusters can be continuously merged together until optimum balances between cluster cohesions and cluster average distances are found.

In some embodiments, the boundaries of the operation clusters can be determined using a hierarchical clustering algorithm. For example, two operation clusters can be merged as long as the cluster average distance is smaller than the sum of the cluster cohesion. Additionally, in some embodiments, a threshold cluster cohesion and/or cluster average distance may be used to cluster the operations. Further, in certain implementations, the operation clusters can be determined by merging operation clusters until an overlap between operation clusters would occur.

In further embodiments, an association certainty can be calculated based on the level of certainty that a given operation should be associated with an operation cluster. For example, if an operation has a higher than average cluster average distance between one or more operations in the cluster, than a low level of association certainty with the operation cluster can be assigned to the operation.

In 230, abstract operations can be generated for the operation clusters. For example, an abstract operation may be generated for each operation cluster. Further embodiments may allow for generation of an abstract operation from multiple operation clusters, generation of multiple abstract operations for a single operation cluster, and generation of abstract operations for overlapping operation clusters.

A name for the abstract operation can be generated based on each operation cluster. In certain implementations, similar keywords from the operations, in particular, the names of the operations, can be analyzed and a common or highly used name or keyword can be assigned to the abstract operation. For example, an operation cluster may include an operation named deposit, an operation named customer_deposit, and an operation named Client_Deposit, The computing device could determine that the word deposit is commonly used among the operation names and assign the name deposit to the abstract operation.

Input/output parameter names and types of the abstract operations can be generated based on the operation clusters. In certain implementations, similar keywords from the operations, in particular the names of inputs/outputs of the operations, can be analyzed and common or highly used input/output names or keywords can be assigned to the inputs/outputs of the abstract operation. Further, inputs/outputs can be analyzed based on the input/output type, and inputs/outputs of the same or similar types can be assigned to the inputs/outputs of the abstract operation. For example, an operation cluster may include operations that result in outputs: account_balance of type float, balance of type float, and AccountBalance of type integer. The computing device could determine that the word balance is common among the set of outputs, that the set of outputs are all number types, that the most common output type is float, and can, accordingly, assign the name balance and the type float to an output of the abstract operation.

In. 240, the inputs/outputs generated for the abstract operations in 230 can be mapped to the inputs/outputs of the concrete operations from which the abstract operations created. Using the above example, the output titled balance of the abstract operation can be mapped to the outputs titled account_balance, balance, and AccountBalance of the respective concrete operations.

In some embodiments, if the output of the concrete operation is of a different type than the output of the abstract operation, then the output of the concrete operation can be converted into the appropriate type or can be wrapped in an object that can be accepted by the abstract operation.

Similarly, in further embodiments, if the input of the concrete operation is of a different type than the input of the abstract operation, then the input of the abstract operation can be converted in to the type required by the concrete operation, or can be wrapped into an object that can be accepted by the concrete operation.

In 250, the inputs/outputs generated for the abstract operations in 230 can be mapped between abstract operations. The computing device can compare input/output names and types and can map inputs/outputs with similar names and/or types. For example, an abstract operation titled account_verification may have an integer output titled account_number and an abstract operation titled deposit may have an integer input titled accountnumber. Accordingly, the computing device can determine, based on the similarity of the respective input and output, that the account_number output can be mapped to the accountnumber input.

Additionally, the computing device can analysis the mappings of input/outputs from the concrete operations of the services and create similar mappings between the abstract operations.

Those skilled in the art will appreciate that the foregoing sequence of steps is exemplary only, and that other sequences may be used for performing embodiments of the invention. For example, in certain implementations, the inputs/outputs of the abstract operations may not mapped to the concrete operations until a new service is instantiated.

Further, in some embodiments, the described steps aforementioned may be invoked in different orders. For example, the inputs/outputs generated for the abstract operations may be mapped between abstract operations before or at the same time as the inputs and outputs are mapped to the respective inputs/outputs of the concrete operations. Other variations on the above steps may be utilized or steps may be removed or added, consistent with certain disclosed embodiments.

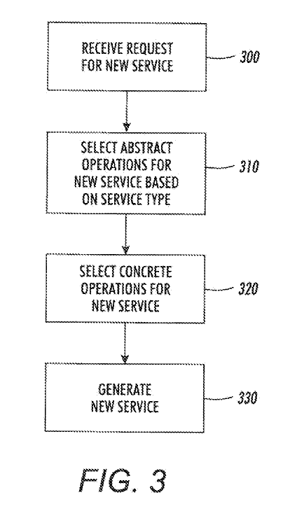

FIG. 3 is a flow diagram illustrating an exemplary method for instantiating a new service using abstract operations, consistent with certain disclosed embodiments.

In 300, a computing device can receive a request for a new service. For example, the computing device could receive a request for a banking service,

Further, in some embodiments, the computing device can receive requirements for the new service with the request for the new service. For example, the requirements can include a maximum cost for the service, a maximum average runtime for the service, a maximum file size for the service, etc.

In 310, the computing device can select abstract operations for the new service. For example, if a request for a banking service is received, the computing device can select abstract operations that include, but are not limited to, AccountVerification, Deposit, and Withdrawal.

In 320, the computing device can select concrete operations associated with the selected abstract operations for the new service. In some embodiments, the concrete operations can be selected based on the requirements of the new service. For example, one or more concrete operations may be associated with a price, and a requirement of the new service may be a maximum price for all concrete operations. Accordingly, the computing device can select concrete operations so that a total price does not exceed the required maximum price.

Additionally or alternatively, one or more concrete operations may be associated with an average runtime for the operation, and a requirement of the new service may be a maximum runtime for certain operations or for the service as a whole. Accordingly, the computing device can select concrete operations so that a total average runtime of one or more concrete operations does not exceed the required maximum average runtime. Additional requirements can include, but are not Limited to, total file size of the service, allowed unmapped inputs and/or outputs, and minimum association certainty between operation clusters and concrete operations.

Further, in some embodiments, a new service may require a concrete operation that the computing device does not have access to or that has not been created. In such embodiments, a received requirement may be the maximum number of missing concrete operations allowed.

In 330, the computing device can generate the new service using the concrete operations selected in 320 and any missing operations, any missing inputs and/or outputs, and/or any incompatible inputs and/or outputs can be indicated to a user of the new service.

In some embodiments, generating the new service may further include mapping inputs/outputs of the selected abstract operations to inputs/outputs of the selected concrete operations. The computing device can further generate glue code, if necessary, to allow the selected concrete operations to invoke other selected concrete operations and/or receive input or provide output to other selected concrete operations.

Those skilled in the art will appreciate that the foregoing sequence of steps is exemplary only, and that other sequences may be used for performing embodiments of the invention. Other variations on the above steps may be utilized, or steps may be removed or added, consistent with certain disclosed embodiments.

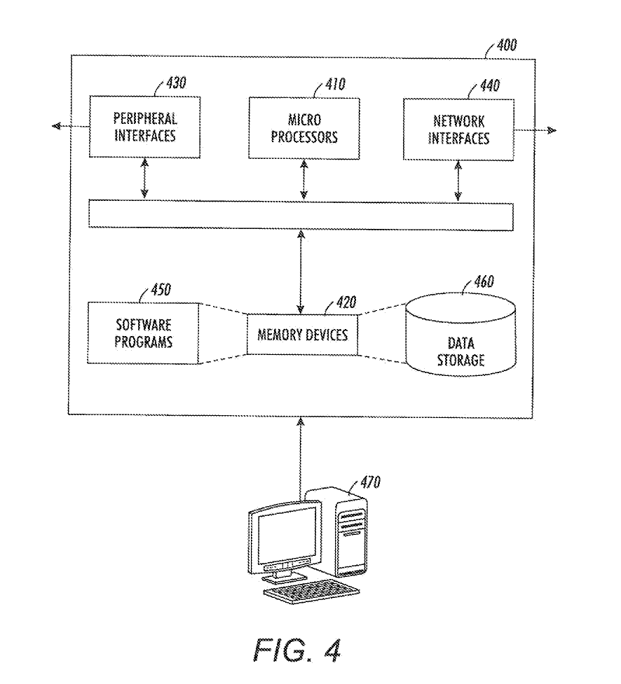

FIG. 4 is a diagram depicting an exemplary hardware configuration 400 for various devices that may be used to perform one or more operations of the described embodiments. As described above, certain operations can be performed by one or more of computing devices 470, which may be, for example, traditional personal computing devices, such as desktop or laptop computers mobile devices, such as smartphones or tablets; kiosk terminals, etc. Additionally, in some embodiments, computing device 470 may be a rack-mounted server device or a conventional desktop computing device, capable of serving web pages and executing server-side scripts or programs.

Computing device 470 may perform operations pursuant to executable or interpretable code resident in memory. Additionally computing device 470 can comprise one or more microprocessors 410 of varying core configurations and clock frequencies; one or more memory devices or computer-readable media 420 of varying physical dimensions and storage capacities, such as flash drives, hard drives, random access memory, etc., for storing data, such as images, files, and program instructions for execution by one or more microprocessors 410; one or more network interfaces 440, such as Ethernet adapters, wireless transceivers, or serial network components, for communicating over wired or wireless media using protocols, such as Ethernet, wireless Ethernet, code divisional multiple access (CDMA), time division multiple access (TDMA), etc.; and one or more peripheral interfaces 430, such as keyboards, mice, touchpads, computer screens, touchscreens, etc., for enabling human interaction with and manipulation of computing device 470. In some embodiments, the components of hardware configuration 400 need not be enclosed within a single enclosure or even located in close proximity to one another.

Memory devices 420 may further be physically or logically arranged or configured to provide for or store one or more data stores 460, such as one or more file systems or databases, and one or more software programs 450, which may contain interpretable or executable instructions for performing one or more of the disclosed embodiments. Those skilled in the art will appreciate that the above-described componentry is exemplary only, as computing device 470 may comprise any type of hardware componentry, including any necessary accompanying firmware or software, for performing the disclosed embodiments. Computing device 470 can also be implemented in part or in whole by electronic circuit components or processors, such as application-specific integrated circuits (ASICs) or field-programmable gate arrays (FPGAs).

The foregoing description of the invention, along with its associated embodiments, has been presented for purposes of illustration only. It is not exhaustive and does not limit the invention to the precise form disclosed. Those skilled in the art will appreciate from the foregoing description that modifications and variations are possible in light of the above teachings or may be acquired from practicing the invention. The steps described need not be performed in the same sequence discussed or with the same degree of separation. Likewise various steps may be omitted, repeated, or combined, as necessary, to achieve the same or similar objectives or enhancements. Accordingly, the invention is not limited to the above-described embodiments, but instead is defined by the appended claims in light of their full scope of equivalents.

What is claimed is:

1. A computer-implemented method for instantiating custom services based on a plurality of operations from a plurality of services comprising:
identifying keywords associated with a service of the plurality of services, wherein one or more of the keywords are associated with an operation of the plurality operations and the operation is associated with the service;
clustering the service into a service cluster from the plurality of services based on the keywords associated with the service;
clustering the operation into an operation cluster from the plurality of operations based on the keywords associated with the operation; and
generating, using on or more processors, an abstract operation based on the operation cluster, wherein the abstract operation define:
one or more inputs required to invoke operations in the operation cluster; and
one or more outputs produced by the operations in the operation cluster,

2. The method of claim 1, wherein identifying keywords associated with the service comprises identifying keywords from a specification associated with the service.

3. The method of claim 1, wherein identifying keywords associated with the service comprises identifying keywords from source code of the service.

4. The method of claim 1, wherein clustering the operation into the operation cluster from the plurality of operations is further based on the service cluster of the service.

5. The method of claim 1, further comprising mapping inputs and outputs defined in the abstract operation to inputs and outputs of each operation in the operation cluster.

6. The method of claim 5, further comprising identifying a failure to map an input defined in the abstract operation to an input of the operation.

7. The method of claim I, further comprising mapping inputs and outputs defined in the abstract operation to different abstract operations associated with the service cluster.

8. The method of claim 1, further comprising:
receiving a request for a new service;
identifying a service cluster of the new service;
selecting an abstract operation for the new service based on the service cluster of the new service; and
selecting a concrete operation for the new service based on the abstract operation for the new service.

9. The method of claim 8, further comprising receiving parameters for the new service; and
wherein selecting the concrete operation for the new service comprises selecting the operation based on the parameters.

10. The method of claim 8, further comprising mapping inputs and outputs defined in the abstract operation for the new service to inputs and outputs of the concrete operation.

11. A system for instantiating custom services based on a plurality of operations from a plurality of services comprising:
a processing system comprising one or more processors; and
a memory system comprising one or more computer-readable media, wherein the computer-readable media contains instructions stored thereon that, if executed by the processing system, cause the system to perform operations comprising:
identifying keywords associated with a service of the plurality of services, wherein one or more of the keywords are associated with an operation of the plurality operations and the operation is associated with the service;
clustering the service into a service cluster from the plurality of services based on the keywords associated with the service;
clustering the operation into an operation cluster from the plurality of operations based on the keywords associated with the operation; and
generating an abstract operation based on the operation cluster, wherein the abstract operation defines:
one or more inputs required to invoke operations in the operation cluster; and
one or more outputs produced by the operations in the operation cluster.

12. The system of claim 11, wherein identifying keywords associated with the service comprises identifying keywords from a specification associated with the service.

13. The system of claim 11, wherein identifying keywords associated with the service comprises identifying keywords from source code of the service.

14. The system of claim 11, wherein clustering the operation into the operation cluster from the plurality of operations is further based on the service cluster of the service.

15. The system of claim 11, the operations further comprising mapping inputs and outputs defined in the abstract operation to inputs and outputs of each operation in the operation cluster.

16. The system of claim 15, the operations further comprising identifying a failure to map an input defined in the abstract operation to the input of the operation.

17. The system of claim 11, the operations further comprising mapping inputs and outputs defined in the abstract operation to different abstract operations associated with the service cluster.

18. The system of claim 11, the operations further comprising:
receiving a request for a new service;
identifying a service cluster of the new service selecting an abstract operation for the new service based on the service cluster of the new service; and
selecting a concrete operation for the w service based on the abstract operation for the new service.

19. The system of claim 11, the operations further comprising receiving parameters for the new service; and
wherein selecting the concrete operation for the new service comprises selecting the operation based on the parameters.

20. The system of claim 17, the operations further comprising further comprising mapping inputs and outputs defined in the abstract operation for the new service to inputs and outputs of the concrete operation.
